(19) United States
(12) Patent Application Publication
(10) Pub. No.: US 2006/0094266 A1
(43) Pub. Date: May 4, 2006

(54) Electrical connector having protecting device

(75) Inventors: Fang-Jwu Liao, Tu-Chen (TW); Igor Polnyi, Aurora, IL (US)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND CO., LTD.

(21) Appl. No.: 10/979,929

(22) Filed: Nov. 1, 2004

(51) Int. Cl. H01R 12/00

(52) U.S. Cl. 439/71

(57) ABSTRACT

An electrical connector (100) for electrically connecting an IC module to a printed circuit board includes a housing (1), a number of electrical contacts (2) received in the housing, a protecting device (3) floatable assembled with the housing, and an elastic device retained and sandwiched between the protecting device and the insulative housing. The contacts are divided into plural groups, each contact has an elastic contacting portion (221) projecting out of the housing. The protecting device can float up and down in a higher and lower positions, in the higher position the protecting device is supported by the elastic device, the contacting portions of the contacts are within the corresponding slots, and in the lower position the protecting device is pressed down, the contacting portions of the contacts project out of the slots.

### BACKGROUND OF THE INVENTION

1. Field of the Invention

The present invention relates to an electrical connector for electrically connecting a land grid array (LGA) integrated circuit (IC) to a printed circuit board (PCB).

2. Description of Related Art

An electrical connector used for electrically connecting an LGA electrical component to a PCB is widely applied in the field of electronics. A conventional electrical connector used for electrically connecting an LGA IC module to a PCB comprises an insulative housing defining a plurality of passageways for receiving a corresponding plurality of contacts. In additional, the insulative housing defines a matting surface for supporting the IC module. In order to obtain excellent elasticity for ensuring reliable electrical connection, each contact has a long elastic arm with a free end, and the free end is beyond the mating surface as a contacting portion of each contact. While the electrical connector is put into use, the IC module presses on the contacting portion to make the contact transform elastically. However, the contacting portions protrude from the mating surface, the contacting portion is easy to be bended or damaged by factors such as rough handling or accidental impact, which will weaken, even destroy, the electrical connection between the IC module and the connector.

Thereby, an improved electrical connector is required to overcome the disadvantages of the prior art.

### SUMMARY OF THE INVENTION

An object of the present invention is to provide an electrical connector having a protecting device which can avoid the contacts of the electrical connector to be damaged.

In order to achieve above-mentioned object, an electrical connector in accordance with a preferred embodiment of the present invention includes a housing, a number of contacts received in the housing, a protecting device floatable assembled with the housing, and an elastic device retained and sandwiched between the protecting device and the housing. The contacts are divided into plural groups, each contact has an elastic contacting portion projecting out of the housing. The protecting device can float up and down in a higher and lower positions, in the higher position the protecting device is supported by the elastic device, the contacting portions of the contacts are within the corresponding slots, and in the lower position the protecting device is pressed down, the contacting portions of the contacts project out of the slots.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is a simplified, exploded, perspective view of an electrical connector in accordance with the preferred embodiment of the present invention, showing a piece of protecting plate reversed;

FIG. 2 is a partly assembled view showing housing-plates of FIG. 1 assembled to form an insulative housing;

FIG. 3 is an assembled view of the electrical connector of FIG. 1

FIG. 4 is a cross-section view taken along line 4-4 of FIG. 3, showing protecting plates of the electrical connector in a first position;

FIG. 5 is a view similar to FIG. 4, but showing the protecting plates in a second position;

FIG. 6 is an assembled view of the electrical connector assembling with a pick up cap.

### DETAILED DESCRIPTION OF THE INVENTION

Reference will now be made to the drawing figures to describe the present invention in detail.

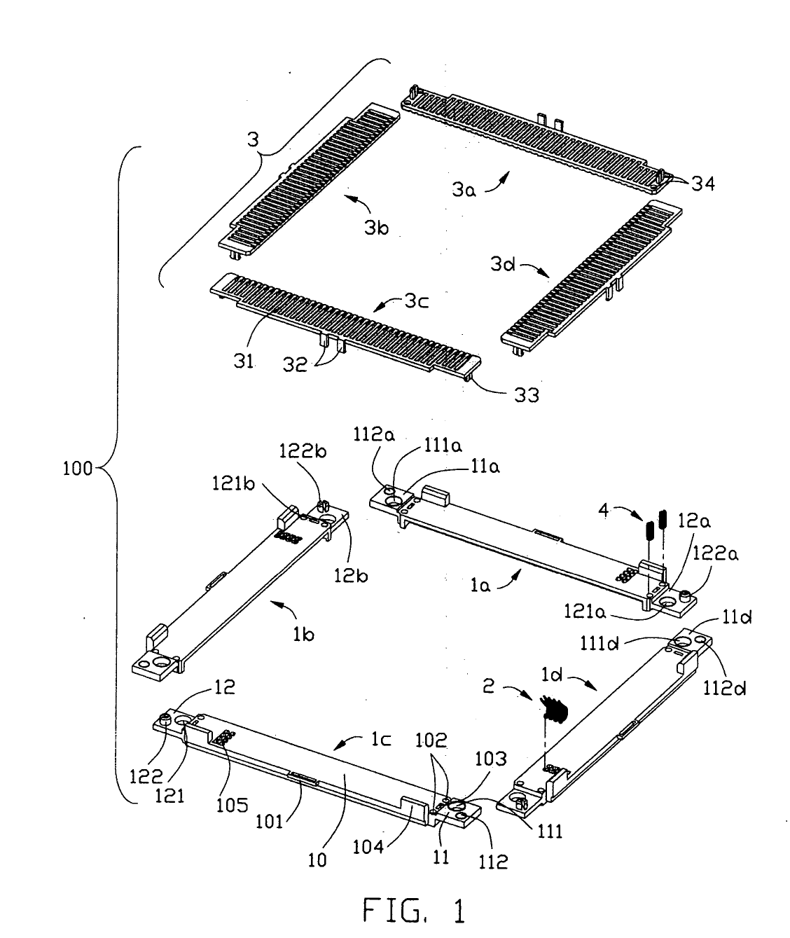

Referring to FIG. 1, an electrical connector 100 in accordance with the preferred embodiment of the present invention comprises an insulative housing 1, a plurality of contacts 2 to be received in the housing 1, a protecting device 3 for protecting the contacts 2, and elastic device for linking the protecting device 3 and the housing 1. Springs 4 are chose for acting as the elastic device in this embodiment.

The insulative housing 1 comprises four pieces of separated housing-plates 1a, 1b, 1c, 1d. As each piece of housing-plate 1a, 1b, 1c, 1d is much smaller than a conventional single-piece housing, it will suffer a littler warp during the cooling course after it is molded. Therefore flatness and reliability of the insulative housing 1 can be controlled more easily. The four housing-plates 1a, 1b, 1c, 1d are of the same structure, we will refer to the housing-plate 1c to be typical of all the housing-plates 1a, 1b, 1c, 1d to describe their structure. Each housing-plate has a shape of rectangle and comprises a first end 11, a second end 12 and a middle portion 10 therebetween. The middle portion 10 of each housing-plate defines a plurality of passageways 105 in rows and columns (only partially shown) for receiving the electrical contacts 2. The middle portion 10 has a first upper surface and a first lower surface, the passageways 105 extend through the first upper and lower surfaces.

At the middle portion 10 adjacent to the two ends 11 and 12 respectively, there are a rim 104 protruding from outer edges thereof, a pair of first blind holes 102 for accommodating one ends of the springs 4, and a latching hole 103 between the first blind holes 102. The first blind holes 102 communicate with the first upper surface and block in the first lower surface. Additionally, an ear 101 projects outwardly from the middle point of a longitudinal edge of the middle portion 10. The ear 101 defines a latching hole therethrough.

The two ends 11 and 12 are both thinner than the middle portion 10, the first end 11 has a bottom surface upper than that of the middle portion 10 and the second end 12 has a top surface lower than that of the middle portion 10. The first end 11 defines a binding hole 112 and a first aligning hole 111. The second end 12 has a binding tab 122 and a second aligning hole 121.

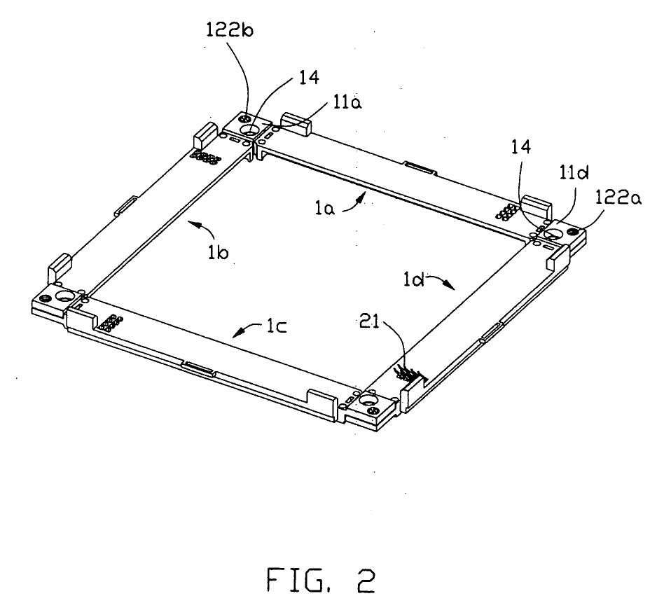

Referring to FIGS. 1 and 2, the four pieces of housing-plates 1a, 1b, 1c, 1d are joined end by end. Now, a process how to join the housing-plate 1a with other two housing-plates 1b and 1d will be described as an example. The housing-plates 1a and 1b are disposed in a position that they are perpendicular to each other. Then the first end 11a of the housing-plate 1a is overlapped onto the second end 12b of the housing-plate 1b, together to make up a thickness proximate to that of the middle portion 10, while the first aligning hole 111a aligning with a second aligning hole 121b to form a unitary hole 14, and the binding tab 122b being received in the binding hole 112a to bind the two plates 1a, 1b. As the binding tab 122b has a diameter slightly larger than that of the binding hole 112a, the two plate 1a, 1b are toughly assembled together after the binding tab 122b is forced into the binding hole 112a. Alike, the housing-plates 1a and 1d are joined in a similar way, that the second end 12a of the housing-plate 1a is overlapped to the first end 12d of the housing-plate 1d with the second aligning hole 121a aligning with the first aligning hole 111d and the binding tab 122a received within the binding hole 112d.

The contacts 2 are arranged in the insulative housing 1 in rows and columns. Each contact 2 comprises a main body 21 retained in the passageways 105, a spring arm 22 extending upwards along an inclined direction beyond the first upper surface, and a soldering portion 23 extending downwards and projecting out of the first lower surface. The spring arm 22 has a curved free end as a contacting portion 221 to electrically connect with the IC module. The contacts 2 are divide into many rows or groups in array. In a row or group, the spring arms 22 of the contacts are parallel to each other and incline along a same direction in a fictitious plane which is perpendicular to the first upper surface of the insulative housing 1. Shadows of neighboring spring arms of the contacts in a row partially overlap on the first upper surface of the housing.

The protecting device 3 floatable assembles with the insulative housing 1, comprises four pieces of protecting plates 3a, 3b, 3c, 3d corresponding to the four pieces of housing-plates 1a, 1b, 1c, 1d. Each protecting plate respectively corresponds to and assemblies with each housing-plate. The four pieces of protecting plates are of the same structure, as shown in FIG. 1, the protecting plate 3c is introduced as an example as below. The protecting plate 3c has a shape of rectangle which similar to the shape of the housing-plates, and comprises a pair of middle latching members 32 and a pair of end latching members 33 downwardly protruding thereof. The latching members 32, 33 are respectively corresponding to the latching holes of the housing-plates. The protecting plate 3c has a second upper surface and a second lower surface opposite to each other. At each end the protecting plate 3c defines a pair of second blind holes 34, correspond to the first blind holes 102 of the housing-plates, for accommodating the other ends of the springs 4. The second blind holes 34 communicate with the second lower surface and block in the second upper surface.

In additional, the protecting plate 3c defines a plurality of parallel slots 31 which extend through the second upper and lower surfaces and extend along a breadth direction perpendicular to the longitudinal direction of protecting plate 3c. Each slot 31 corresponds to a row of contacts 2 along the breadth direction and provides a free space for the corresponding group of contacts during the protecting device floating up and down. Along extending direction of corresponding slots a plurality of notches 311 are formed to communicate with corresponding slots 31 at the edge of the second upper surface.

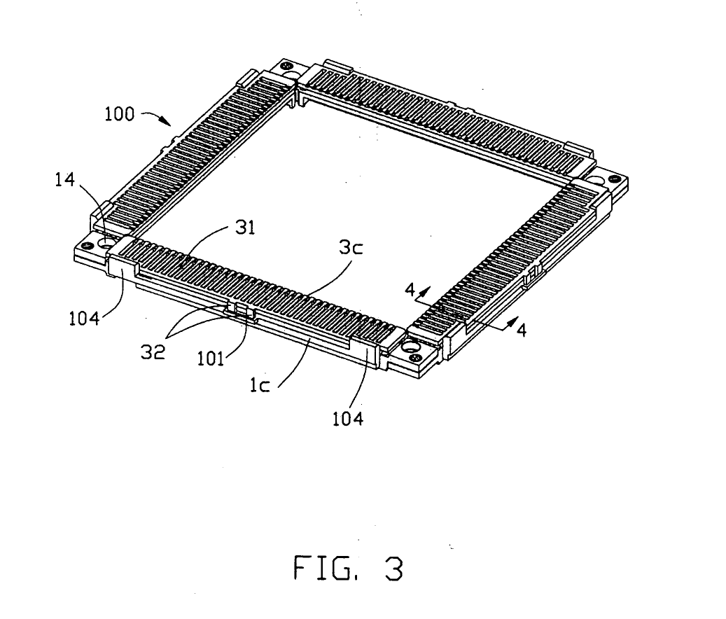

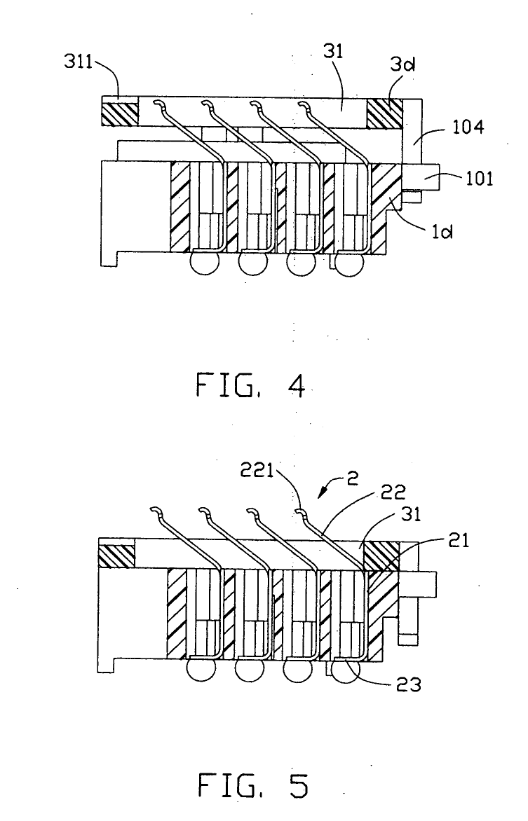

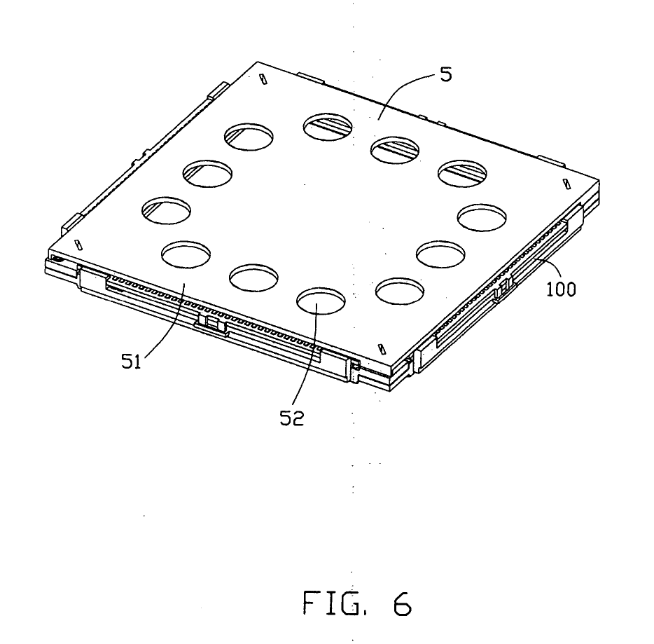

Referring to FIG. 3, the protecting device 3 assembles with the insulative housing together to form the electrical connector 100, in assembly, the latching members 32, 33 of the protecting device 3 engage with the latching holes 103 of the insulative housing 1, and the springs 4 sandwiched therebetween with elastic force, two free ends of each spring 4 respectively received in the corresponding blind holes 34, 102 of the protecting device 3 and the insulative housing 1. The protecting plates 3a, 3b, 3c, 3d of the protecting device 3 are respectively parallel to the housing-plate 1a, 1b, 1c, 1d of the insulative housing 1, and shown in FIG. 4, a space is defined between the first upper surface of the insulative housing 1 and a second lower surface of the protecting plate 3. Thus, if loading or unloading a sufficient external force, the protecting device 3 can float down and up without breaking off the insulative housing 1.

As shown in FIGS. 3-4, in a first position, the electrical connector 100 is unused to electrically connect an IC module, the protecting device 3 is spaced from the insulative housing 1, and the contacting portions 221 of the contacts 2 project out of the first upper surface of the insulative housing 1, but not project out of the second upper surface of the protecting plates of the protecting device 3. The contacting portions of the contacts 2 in one row are accommodated within one slot 31 of the protecting plates, and the spring can resist a certain external force and assure the contacts 2 should not be damaged. Thus, while the assembled electrical connectors 100 are left unused, being storied or carried, the protecting device 3 is supported by the springs 4 in the first position to prevent the spring arms 22 from accidental damage.

In a second position, as shown in FIG. 5, a sufficient external force loaded on the protecting plate 3, the space eliminates between the protecting plate 3 and the insulative housing 1, the contacts 2 are still in a relaxed manner, but the contacting portions 221 of the contact 2 project out of the slot 31 and the second upper surface of the protecting plate 3. When the electrical connector 100 is to electrically connect to the IC module, the protecting device 3 needn't to be removed, the IC module can be directly press on the protecting device 3 and make it float down, and the spring arms 221 of the contacts 2 in a same slot 31 are pressed to grovel towards the corresponding notches 311, finally, the IC module is fixed on the protecting plate 3 and electrically connect with the contacting portions 221 of the contacts 2. If removing the IC module, the springs 4 can provide an elastic force to urge the protecting device 3 from the second position to the first position.

Moreover, FIG. 5 shows a pick up cap 5 to be assembled to the electrical connector 100. The pick up cap 5 comprises a flat plate 51 defining a circle of through holes 52 therein, and four retention posts 53 respectively extending down from four corners of the flat plate 51 to be received in the unitary hole 14 of the housing 1 to retain the pick up cap 5 to the electrical connector 100. FIG. 5 shows the pick up cap 5 being assembled to the electrical connector 100. During transmitting of the electrical connector 100, the pick up cap can be catch up by a cupule. Thus, in virtue of the pick up cap 5, the electrical connector 100 can be picked up conveniently.

The disclosure is illustrative only, changes may made in detail, especially in matter of shape, size, and arrangement of parts within the principles of the invention.

1. An electrical connector for electrically connecting an IC module to a printed circuit board, comprising:
a housing having a first upper surface and defining a plurality of passageways;
a plurality groups of contacts received in the passageways, each group comprising at least two contacts, each contact having a contacting portion projecting out of the first upper surface of the housing;
a protecting device floatably attached on the first upper surface of the housing, and defining a plurality of slots, each slot providing a free space for the corresponding group of contacts during the protecting device floating up and down, and having a second upper surface over the contacting portions of the contacts in an upper position and under the contacting portions of the contacts in a lower position, and
an elastic device retained and sandwiched between the protecting device and the housing, and providing an elastic force to urge the protecting device from the lower position to the upper position.

2. The electrical connector as described in claim 1, wherein the housing has a first lower surface, and the passageways extend through the first upper and lower surfaces.

3. The electrical connector as described in claim 2, wherein the housing defines a pair of first blind holes adjacent to each end thereof, the first blind holes communicate with the first upper surface and blocked in the first lower surface.

4. The electrical connector as described in claim 3, wherein the protecting device has a second lower surface, the holes extend through the second upper and lower surfaces.

5. The electrical connector as described in claim 4, wherein the protecting device defines a pair of second blind holes corresponding to the first blind holes of the insulative housing, and the second blind holes communicate with the second lower surface and blocked in the second upper surface.

6. The electrical connector as described in claim 5, wherein the elastic device is springs, and each spring is sandwiched between one of the first blind holes and corresponding second blind hole.

7. The electrical connector as described in claim 6, wherein the housing defines a latching hole between the first blind holes at each end and an ear with a latching hole projecting outwardly from a middle portion, and the protecting device forms corresponding latching members for engaging with the latching holes of the housing.

8. The electrical connector as described in claim 1, wherein the housing has four pieces housing-plates, each housing-plate has a shape of rectangle and comprises a first end, a second end and a middle portion therebetween, the housing-plates are joined end by end.

9. The electrical connector as described in claim 8, wherein the first and second ends are both thinner than the middle portion, the first end has a bottom surface upper than that of the middle portion and the second end has a top surface lower than that of the middle portion, the first end defines a binding hole and the second end has a binding tab for engaging with the binding hole of anther piece housing-plate.

10. The electrical connector as described in claim 1, wherein each contact has a spring arm extending upwards along an inclined direction beyond the housing, and the spring arm of the contacts in a group are parallel to each other and incline along a saine direction in a plane which is perpendicular to an upper surface of the housing.

11. The electrical connector as described in claim 10, wherein projection of neighbouring spring arms of the contacts in a group partially overlap on the first upper surface of the housing.

12. The electrical connector as described in claim 1, wherein the slots of the protecting device are parallel to each other.

13. The electrical connector as described in claim 1, wherein a plurality of notches are formed to communicate with corresponding slots at one edge thereof along an extending direction of corresponding slots.

14. An electrical connector assembly comprising:
a housing retaining a plurality of contacts in rows and columns, each contact having a contacting portion over the housing;
a floating plate movably assembled onto the housing to go beyond or expose the contacting portions of the contacts, defining parallel slots, each slot extending along and accommodating corresponding at least one corresponding row of the contacts;
a linking device assembling the housing and the floating plate together, to assure the protecting plate beyond the contacting portions of the contacts in a free condition and allow the protecting plate sink below the contacting portion of the contact under external force.

15. The electrical connector assembly as described in claim 15 blocked, wherein the housing has four pieces of housing-plates, each housing-plate has a shape of rectangle and comprises a first end, a second end and a middle portion therebetween, the housing-plates are joined end by end.

16. The electrical connector assembly as described in claim 14, wherein the first and second ends are both thinner than the middle portion, the first end has a bottom surface upper than that of the middle portion and the second end has a top surface lower than that of the middle portion, the first end defines a binding hole and the second end has a binding tab for engaging with the binding hole of anther piece housing-plate.

17. The electrical connector assembly as described in claim 14, wherein a plurality of notches are formed to communicate with corresponding slots at edges thereof along an extending direction of corresponding slots.

18. The electrical connector assembly as described in claim 14, wherein shadows of neighbouring spring arms of the contacts in a row partially overlap on the first upper surface of the housing.

19. An electrical connector for use with an electronic component, comprising:
an insulative housing;
a plurality of contacts disposed in the housing with upper contact portions extending above the housing; and
a floating plate moveably located above the housing between upper and lower positions in a vertical direction and defining a through slot receiving at least two upper contact portions simultaneously; wherein
when said floating plate is located in the upper position, the upper contact portions are hidden under a top face of the floating plate for protection; when said floating plate is located in the lower position, the upper contact portions are exposed to an exterior above the top face of said floating plate for engagement with said electronic component.

20. The electrical connector as claimed in claim 19, wherein said upper contact portion essentially extends obliquely so as to be essentially located right above an adjacent contact which is located in a direction said upper contact extends along, from a top view of said housing.

21. The electrical connector as claimed in claim 20, wherein said upper contact portions are in a free status.

22. (canceled)

23. The electrical connector as claimed in claim 20, wherein said upper contacts portion are in a free status when said floating plate is located in the upper position.

24. The electrical connector as claimed in claim 19, wherein both said floating plate and said upper contact portions are synchronically moved downwardly by said electronic component during movement of the floating plate from the upper position to the lower position.

25. The electrical connector as claimed in claim 14, wherein the contact portion of each of said contacts extends in an oblique manner to be vertically overlapped with the adjacent contact which is located in a direction said contact portion extends along.
